(19) United States
(12) Patent Application Publication
(10) Pub. No.: US 2005/0042494 A1
(43) Pub. Date: Feb. 24, 2005

(54) Compliant member for wet seal

(76) Inventors: Chao-Yi Yuh, New Milford, CT (US); Michael Cramer, New Milford, CT (US); Mohammad Farooque, Danbury, CT (US); Dana Kelley, New Milford, CT (US); Chris Begley, Keswick, VA (US)

Correspondence Address: COWAN LIEBOWITZ & LATMAN, P.C;JOHN J TORRENTE, 1133 AVENUE OF THE AMERICAS, NEW YORK, NY, 10036, US

(21) Appl. No.: 10/643,544

(22) Filed: Aug. 19, 2003

(51) Int. Cl. H01M 2/08

(52) U.S. Cl. 429/35

(57) ABSTRACT

A compliant member is described for placement in a fuel cell, in a wet seal area thereof, which is defined by a bipolar plate structure and is adjacent an electrode and current collector. The compliant member comprises a flat body member having sections extending outwardly of the plane of the body member and imparting compliance to the compliant member.

### BACKGROUND OF THE INVENTION

This invention relates to fuel cells and, in particular, to a compliant member for use in a wet seal area of a high temperature fuel cell stack. More specifically, this invention relates to a compliant member for maintaining compressive pressure at the wet seal area, which is defined by bipolar plate portions adjacent the perimeter of each fuel cell.

A conventional fuel cell stack typically has several hundred fuel cells in series. In order to work properly, intimate contact must be maintained between all cells in the stack during all stack operating conditions for the duration of the stack's life. Factors to be considered in achieving this requirement include manufacturing tolerances of the cell components, non-uniform thermal expansion of the cell components during operation and long term consolidation of the cell components resulting in shrinkage of the stack. Of particular concern is shrinkage of the cathode member during stack operation, as described further below.

The fuel cells in a carbonate fuel cell stack include a bipolar plate construction. The bipolar plate is a flat, rectangular, gas-impermeable member disposed between two adjacent cells, including a first surface facing one adjacent cell and a second surface facing the other adjacent cell, that provides electrical contact with the current collectors in the adjacent cells. Two opposite edges of the bipolar plate are folded over the first surface of the plate, forming two sealing flanges, and the other two edges are folded over the second surface of the plate, forming two other sealing flanges. At least a portion of each of the sealing flanges includes a flat section of the folded-over edge that is parallel to and spaced apart from the first or second surface of the bipolar plate. The area between the flat section of each folded-over edge and the corresponding first or second surface from which the flat section is spaced apart defines two wet seal areas on each side of the bipolar plate. The area between the two wet seal areas adjacent each of the first and second surfaces of the bipolar plate represents a cell active area.

In a typical embodiment of a carbonate fuel cell, the cathode is made of a porous NiO powder bed and is placed in the cell active area but does not extend into the wet seal area due to component height and ease of assembly considerations. Instead, a sheet metal shim of equal thickness is used to replace the cathode in the wet seal area. As a result, the cell perimeter including the metal shim is structurally stronger than the cell active area, in which the cathode is disposed.

The fuel cell stack operates under a compressive load to ensure proper electrical contact between cell components in the fuel cell active areas and to maintain the gas seal in the wet seal areas at the perimeter of the fuel cells. Stack compression pressure is evenly distributed over the fuel cell active area of each fuel cell at the beginning of stack operation, but as the cathode shrinks, the pressure is transferred to the wet seal areas. A similar shift in compression pressure occurs on the anode side of each fuel cell due to anode shrinkage which occurs to a lesser degree than shrinkage of the cathode. In either case, the transfer of compression pressure to the wet seal areas from the cell active area is undesirable because it results in loss of compression in the cell active area which causes an increase in electrical contact resistance and ultimately loss of cell performance.

It would be desirable to have a wet seal area adapted to maintain the distribution of compression pressure to compensate for cathode and anode shrinkage during stack service life, so that electrical contact resistance in the cell active area does not increase. Previous attempts to use cathode members in the wet seal areas at the cell perimeter in order to match the mechanical properties of the cell active area have not been successful.

U.S. Pat. No. 4,514,475 describes a wet seal design in which a bundle of metal layers is inserted under each wet seal area to provide spring characteristics. The spring characteristics rely on imperfections in the surface of the thin metal sheets, which vary from cell to cell and are therefore not reproducible. If the compressibility of the metal sheets is insufficient, the sheets must be mechanically worked to achieve corrugations or waves. The seal also requires assembly of a large number of parts, which adds to the cost and difficulty of manufacturing the seal.

U.S. Pat. No. 4,604,331 describes a bellows-type sealing flange wet seal arrangement. The flange is compressible in a direction normal to the plane of a bipolar plate by incorporating two accordion-pleated side walls on each sealing flange. One of the accordion-pleated side walls connects the flat portion of the flange with the bipolar plate body and the other accordion-pleated side wall is connected to the flat portion of the flange, but stops just short of the bipolar plate body. The resilience of the flange is controlled by inserting a reinforcement member in the passage formed by the flange flat wall and the bipolar plate. This assembly requires fewer parts, but the spring properties of the wet seal bellows of this design are substantially different from the cell package.

It is an object of the present invention to overcome the above and other drawbacks of conventional carbonate fuel cells, solid oxide fuel cells (“SOFC”) and proton exchange membrane (“PEM”) fuel cells and, more particularly, to provide a compliant member at the wet seal area of the fuel cell to maintain distribution of compressive pressure and prevent the corresponding increase in electrical contact resistance during operation of the fuel cell stack.

It is another object of the invention to provide a compliant member that has spring properties similar to the cell package and which accommodates cathode and anode shrinkage yet prevents uncontrolled shrinkage of the sealing flange during operation of the fuel cell stack.

It is another object of the present invention to provide a compliant member for use in the wet seal area of fuel cells in a fuel cell stack that is reliable, inexpensive, and easy to manufacture and install.

### SUMMARY OF THE INVENTION

The above and other objects are achieved by the present invention, which overcomes the disadvantages of sealing flanges in conventional fuel cells by providing a compliant member for use in the wet seal area of a fuel cell. According to the illustrative embodiment, the compliant member of the present invention is used in conjunction with an externally or internally manifolded fuel cell stack having a plurality of fuel cells between first and second end plates and operating under a compressive load to provide electrical contact between cell components in the active area of each fuel cell. Under the compressive load, as the cathode shrinks during operation of the stack, the compliant member of the present invention helps to maintain electrical contact in both the cell active area and the wet seal area. The compliant member is adapted to be compressible in a direction normal to the plane of the bipolar plate while also preventing collapse and uncontrolled shrinkage of the sealing flange.

The compliant member substantially covers the area of the wet seal and includes a flat body member that is adapted to be disposed adjacent the wet seal area. The body member comprises sections extending outwardly from the plane of the body member that allow compression of the compliant member upon shrinkage of the cathode member disposed in the cell active area. The compliant member is comparatively compressible due to movement of the sections toward the body member at the beginning of stack operating life such that as cathode shrinkage occurs, the compression pressure on the cell active area is maintained. Once significant cathode shrinkage has ceased and the compliant member is completely compressed, i.e., the sections are moved into the plane of the body member, the wet seal area is strengthened by the compressed member. The compliant member in a compressed state prevents catastrophic collapse of the wet seal area under high compression pressures. The structure of the compliant member of the present invention, including the flat body member and outwardly-extending sections, thus imparts compliance to the wet seal area of a fuel cell to compensate for cathode shrinkage and corresponding weakening of the cell active area during operation of the fuel cell stack, and prevents uncontrolled shrinkage of the wet seal areas defined by the sealing flanges on each side of the bipolar plate formed by the folded edges of the bipolar plate structure.

A fuel cell stack in accordance with the present invention comprises a plurality of fuel cells including a bipolar plate structure having edges which are folded back over the plate to form two parallel sealing flanges on each surface of the plate. Each sealing flange defines a wet seal area, in which is disposed a compliant member.

### BRIEF DESCRIPTION OF THE DRAWINGS

The above and other features and aspects of the present invention will become more apparent upon reading the following detailed description in conjunction with the accompanying drawings, in which:

FIG. 1A is a detailed perspective view with cut-away portions of a conventional carbonate fuel cell construction;

FIG. 1B is a detailed perspective view of the bipolar plate in the conventional carbonate fuel cell construction of FIG. 1A;

FIG. 2 is a perspective view of a conventional fuel cell with a non-compliant wet seal insert;

FIG. 3 is a perspective view of a fuel cell with a compliant member in accordance with the invention in the wet seal area of the fuel cell;

FIG. 4 is a graphical representation of the deflection properties of the compliant member of FIG. 3 under various compressive loads;

FIG. 5 is a detailed perspective view of the body member and sections of the compliant member of FIG. 3;

FIG. 6A is a top view of the body member and sections of the compliant member of a second embodiment of the invention; and

FIG. 6B is a top view of the body member and sections of the compliant member of a third embodiment of the invention.

### DETAILED DESCRIPTION

The present invention overcomes the above-described disadvantages of wet seal designs in the state of the art by inserting a compliant member to be used in the wet seal adjacent the fuel cell perimeter. Particularly, as shown in the illustrative embodiment and described in further detail below, the wet seal comprises a specially configured compliant member inserted in the wet seal area.

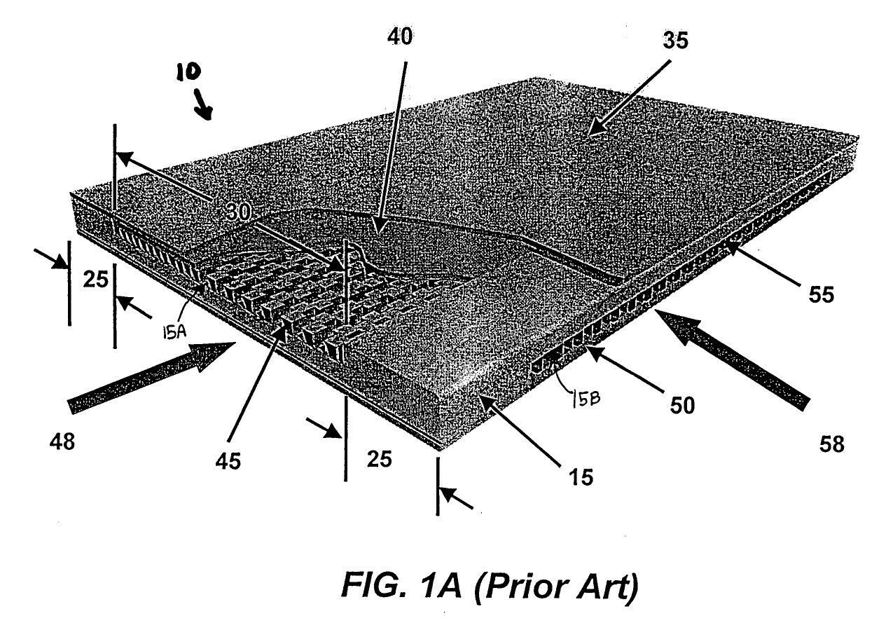

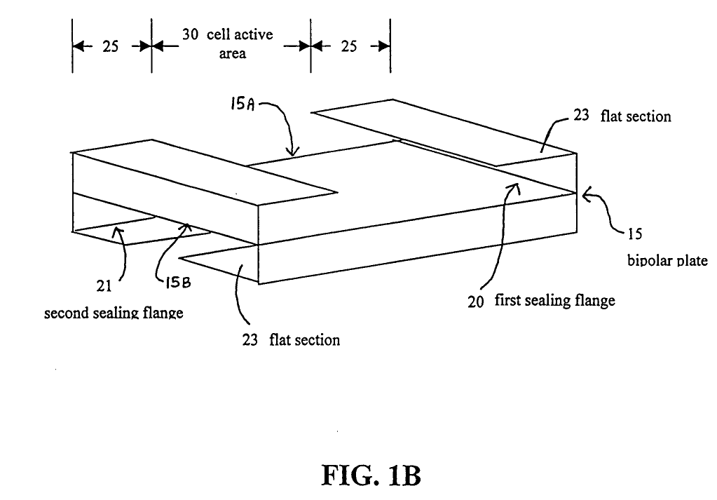

FIG. 1A illustrates a conventional carbonate fuel cell construction 10 in a carbonate fuel cell stack. As shown, bipolar plate 15 separates two adjacent cells, one on each of first and second surfaces 15A, 15B of the bipolar plate. The bipolar plate structure 15 is shown in greater detail in FIG. 1B. As shown in this figure, two opposite edges of the plate 15 are folded over the first surface 15A of the plate to form two sealing flanges 20, and two other opposite edges of the plate 15 are folded over the second surface 15B of the plate to form two sealing flanges 21 disposed perpendicularly to the first two sealing flanges 20. Each of the sealing flanges 20, 21 includes a flat section 23 spaced apart from and disposed substantially parallel to the bipolar plate 15. The sealing flanges 20, 21 including flat sections 23 and portions of the bipolar plate 15 opposite the flat sections 23 define wet seal areas 25 such that there are two parallel wet seal areas 25 adjacent each surface 15A, 15B of the bipolar plate 15. The area between the wet seal areas 25 defines a cell active area 30.

Turning back to FIG. 1A, in a portion of the fuel cell adjacent to the first surface 15A of the bipolar plate is disposed an anode 40 which is sandwiched between a porous matrix layer 35 and an anode current collector 45, the latter abutting the surface 15A of the bipolar plate 15. The anode current collector 45 distributes the fuel gas stream 48 over the anode 40 and conducts electrons from the anode to the bipolar plate 15. Similarly, in a portion of the fuel cell adjacent to the second surface 15B of the bipolar plate 15 is disposed a cathode 50 which is adjacent to a cathode current collector 55 which abuts the bipolar plate surface 15B. The cathode current collector 55 distributes the oxidant 58 over, and conducts electrons delivered to the bipolar plate to, the cathode 50. In the illustrative embodiment, the cathode 50 is a porous nickel oxide powder bed.

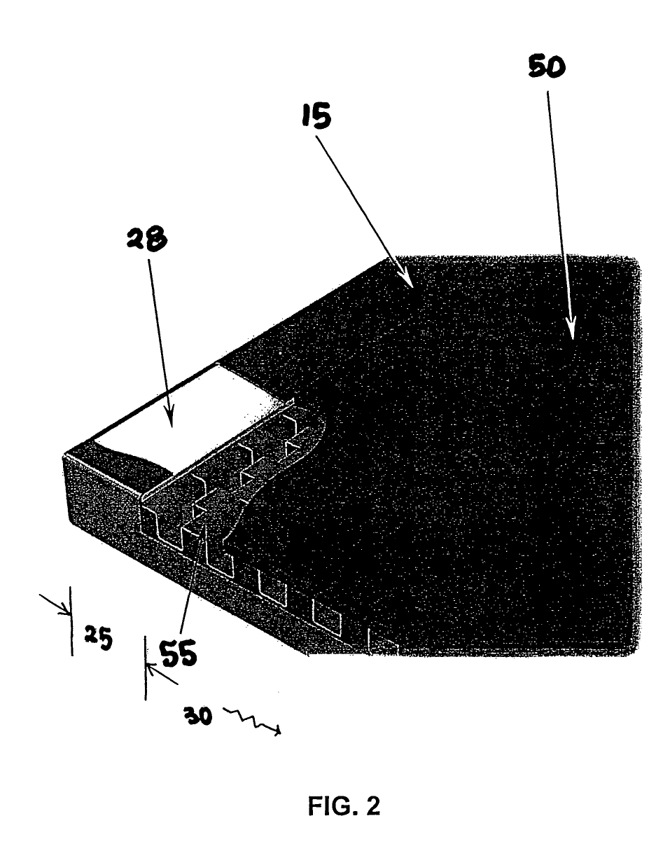

Many fuel cell components undergo dimensional changes during operation of the fuel cell stack, but shrinkage of the cathode 50 is the most significant. As shown in FIG. 2, in a conventional fuel cell, the cathode 50 is disposed only in the cell active area 30. In the wet seal areas 25, the cathode 50 is replaced with a sheet metal shim 28 of equal thickness. As a result, as the cathode 50 shrinks, compressive pressure shifts from the cell active area 30 to the wet seal area 25 including shim 28.

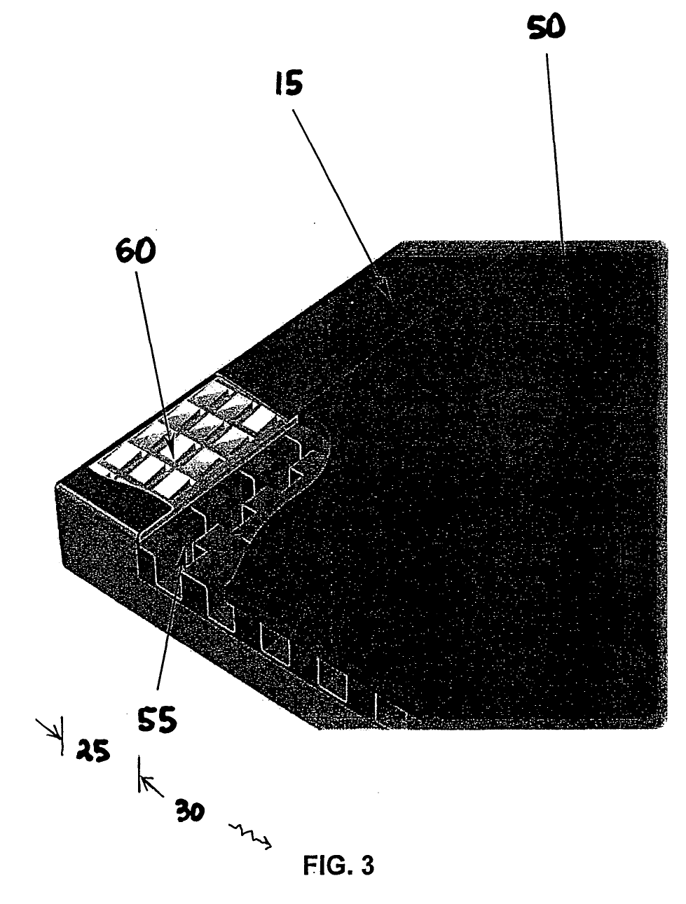

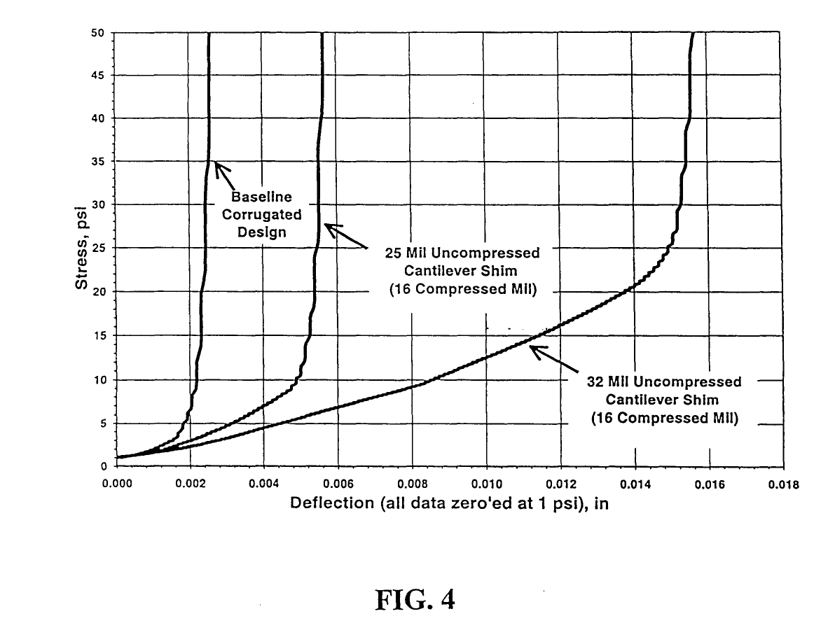

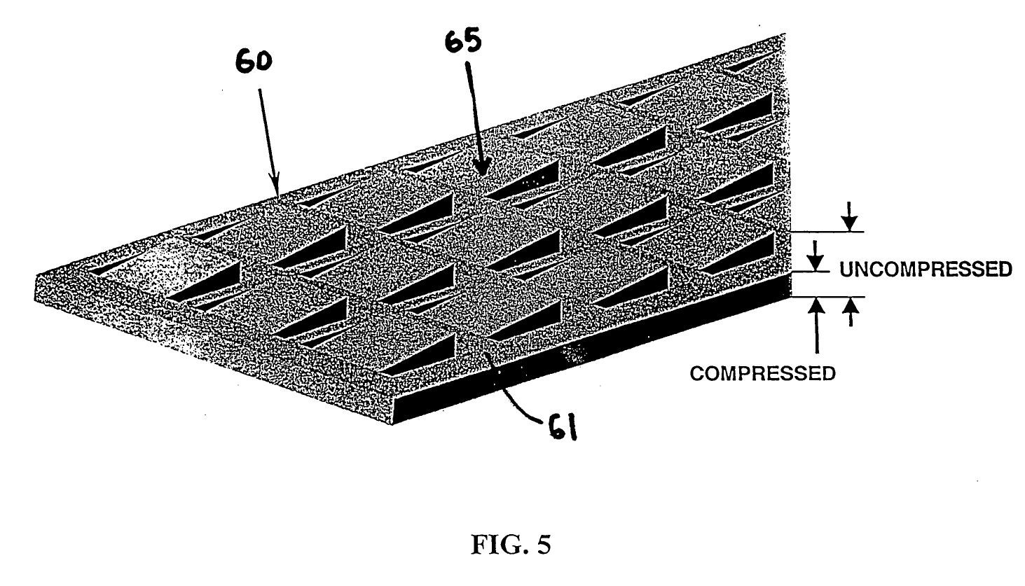

According to the present invention and as shown in FIG. 3, a compliant member 60 is used in the wet seal area 25. As described in further detail below with respect to FIGS. 4 and 5, the member 60 is compressible, so that as the cathode 50 shrinks, the member 60 is correspondingly compressed and electrical contact in the cell active area 30 is maintained, preventing an increase in electrical contact resistance. At higher compressive loads, when the cathode shrinkage is mostly complete, the fully compressed member 60 provides strength to the wet seal area 30 to prevent collapse of the sealing flanges 20, 21.

As can be seen in FIG. 3 and in greater detail in FIG. 5, in accordance with the illustrative embodiment of the invention, the compliant member 60 comprises a flat shim or body member 61 having a generally elongated rectangular shape, with dimensions defined by the dimensions of the wet seal area in which it is disposed. It should be noted that body member 61 of the compliant member 60 can have many alternative configurations and various shapes as defined by the wet seal area in which it is disposed in addition to the generally elongated rectangular shape as shown and described herein.

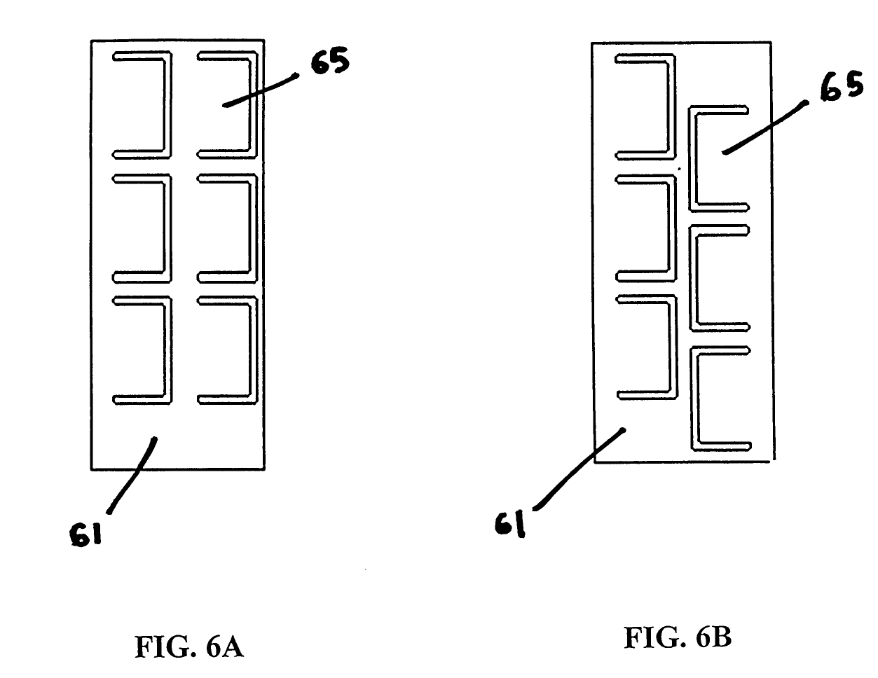

The body member 61 has sections 65 partially cut out therefrom, each of which is joined to the member 61 on one side, as shown in FIG. 5. As also seen in this figure, the sections 65 are joined to the member 61 on the same side such that each section 65 extends outwardly in the same direction in cantilever fashion from the plane of the body member. However, the orientation of sections 65 relative to each other and to the body member 61 may vary. Particularly, as shown in FIGS. 6A and 6B, the sections 65 may be arranged in a side-tabbed or stagger-tabbed configuration. FIG. 6A shows the sections 65 lined up in rows along the length of the body member 61 wherein each section 65 is attached to the member 61 on the same side so that the sections 65 extend outwardly from the plane of the body member 61 towards the long side of the shim. As shown in FIG. 6B, the sections 65 are positioned in staggered rows. The sections in each row are attached to the member 61 on opposite sides, such that the sections 65 in one row extend outwardly from the plane of the body member 61 in a direction opposite the direction in which the sections 65 in an adjacent staggered row extend outwardly from the plane of the body member 61. It is understood that various other configurations are consistent with the compliant member of the present invention.

Each section 65 is angled away from the plane of the body member 61 at approximately the same angle θ. Sections 65 remain in an angled position (where the angle θ is in the range of approximately 2-50 degrees) relative to the body member until a sufficient compressive force is applied and the sections 65 move toward the plane of the body member 61, thereby reducing the angle θ of each section. In the illustrative embodiment, the angle θ before compressive pressure is applied is approximately 4 degrees, and the distance from the side of each section 65 opposite the side joined to the body member 61 to the plane of the body member 61 is approximately in the range of between 0.01 and 0.06 inches.

The sections 65 formed in or cut out from the member 61 provide a significant amount of compliance under stress up to a maximum load, at which point the sections 65 are fully compressed. Beyond a maximum load, the member 61 is no longer compressible; the sections 65 are in the plane of the body member, which acts as a solid sheet that provides strength to the wet seal area and prevents it from collapsing. After being compressed, sections 65 move away from the plane of the body member and return to the original angled position if the compressive pressure is reduced or removed. In this respect, the compliant member 60 is also resilient.

Thus, under a maximum compressive load, the angle θ between sections 65 and the body member 61 is reduced to zero and the sections 65 are in a fully compressed position in the plane of the body member, which provides no further compliance. In flattened state, the body member 61 strengthens and supports the wet seal area of the fuel cell under any further compressive load. With this structure, the body member 61 and sections 65 partially cut out therefrom collectively act as both a compressible spring component that provides compliance during compression, as well as a resilient support member providing strength and support to the wet seal areas of the fuel cell at a maximum level of compression.

Particularly, as shown in FIG. 4, a wet seal structure comprising a corrugated member having a height of approximately 0.069 inches and a flat sheet having a thickness of approximately 0.022 inches, as in the prior art, only provides compliance of up to about 0.0025 inches under a maximum load of approximately 15 psi. A compliant member 60 having a thickness (measured as the height from the bottom of body member 61 to top of sections 65) of 25 mils in an uncompressed state, by contrast, provides almost twice the compliance, or up to approximately 0.0055 in. under a load of up to about 18 psi. If the thickness of the compliant member 60 in an uncompressed state is increased to 32 mils, the member provides compliance of up to as much as 0.015 in. and becomes solid at a compressive load of approximately 25 psi. Thus, the compliant member 60 of the invention can accommodate considerable pressure loss in the cell active area during cathode shrinkage and, as described above, upon reaching a fully compressed state under a maximum compressive load, the compliant member provides strength and support to the wet seal area and prevents it from collapsing.

The compliant member 60 of the invention can be made, for example, from a sheet of metal superalloy material such as Inconel 718, Waspaloy, or Rene-41 or similar high-strength metal superalloy capable of withstanding high-temperature, high-stress conditions. Sections 65 can be formed in the body member by being punched or cut out from the alloy sheet.

Superalloys are preferred for the compliant member 60 because of the high-temperature high-stress conditions of the fuel cell stack. The most commonly used superalloys are precipitating-hardened for strengthening. The superalloy materials for use as the spring or compliant member 60, however, are preferably fabricated by solution-annealing, since it may be difficult to fabricate them from age-hardened materials due to their high hardness. As a result, the superalloy materials prepared by solution-annealing must be properly heat-treated including age hardening after fabrication to regain the desired high strength. Also, the fabrication process can introduce grain deformation and defects that can be the source of material creep at use. The age hardening after the fabrication of the compliant member helps to redress this condition.

It is understood that various other materials with strength and durability at high temperatures and high pressures may also be used in accordance with the present invention. In all cases it is understood that the above-described arrangements are merely illustrative of the many possible specific embodiments that represent applications of the present invention. Numerous and varied other arrangements can be readily devised in accordance with the principles of the present invention without departing from the spirit and the scope of the invention.

1. A compliant member for use in a fuel cell having a plate structure defining a wet seal area, said wet seal area being adjacent an electrode and current collector, said compliant member being arrangeable in said wet seal area and comprising a body member having sections extending outwardly of the plane of the body member, said sections imparting compliance to said compliant member.

2. A compliant member according to claim 1, wherein said body member is configured to be fit within said wet seal area in which said compliant member is arranged.

3. A compliant member according to claim 1, wherein said wet seal area is defined by the region between a flat section and another portion of said plate structure opposite said flat section, said flat section being a part of a flange formed by folding over an edge of said plate structure so that said flat section faces a surface of said plate structure having said another portion.

4. A compliant member according to claim 2, wherein said body member is flat and one side of each of said sections of said body member is joined to said body member.

5. A compliant member according to claim 4, wherein the one side of each of said sections is on the same side of that section as the side that each other one side is on its respective section.

6. A compliant member according to claim 5 wherein said body member and said sections are made from a superalloy material or spring.

7. A compliant member according to claim 6, wherein in the uncompressed state of said compliant member, the side of each of said sections opposite said one side joined to said body member is disposed at a distance of 0.01-0.06 inches from said flat body member, and said sections extend outwardly of the plane of said flat body member at an angle of 2-50 degrees.

8. A compliant member according to claim 7, wherein said angle is reduced as compressive load is applied to said fuel cell.

9. A compliant member according to claim 8, wherein said sections are disposed in the plane of the flat body member when said compliant member is fully compressed.

10. A compliant member according to claim 6 wherein said superalloy material is one of Inconel 718, Waspaloy and Rene-41.

11. A compliant member according to claim 6 wherein said body member and each of said sections is rectangular.

12. A compliant member according to claim 1, wherein said sections are arranged in rows which extend along the length of said body member and which are spaced along the width of said body.

13. A compliant member according to claim 12, wherein one side of each of said sections of said body member is attached to said body member.

14. A compliant member according to claim 13, wherein said one side of each of said sections extends along one of the length of said body member and the width of said body member.

15. A compliant member according to claim 14, wherein the one side of each of said sections extends along the length of said body member.

16. A compliant member according to claim 14, wherein the one side of each of said sections extends along the width of said body member.

17. A compliant member according to claim 12, wherein said rows of sections are offset one from the other in the length direction of said body member.

18. A fuel cell for use in a fuel cell stack, said fuel cell having a plate structure defining an active fuel cell area and a wet seal area bordering said active fuel cell area, said fuel cell further comprising:
a current collector abutting said active fuel cell area and extending into said wet seal area;
an electrode abutting said current collector over a region which excludes the region of said current collector extending into said wet seal area;
a compliant member abutting said current collector over a region of said current collector extending into said wet seal area, said compliant member comprising a body member having sections extending outwardly of the plane of the body member, said sections imparting compliance to said compliant member.

19. A fuel cell according to claim 18, wherein two opposite edges of said plate structure are folded over a first surface of said plate structure forming two flanges adjacent said first surface of said plate structure, each of said flanges comprising a flat section spaced apart from and parallel to said first surface of said plate structure, said wet seal area being defined by the region between a flat section of a first one of said two flanges and a portion of said first surface of said plate structure opposite that flat section.

20. A fuel cell according to claim 19, wherein said active fuel cell area is the area between said two flanges on said first surface of said plate structure.

21. A fuel cell according to claim 20, wherein said electrode is one of a cathode and an anode electrode.

22. A fuel cell according to claim 21, further comprising a further compliant member abutting said current collector over a region of said current collector extending into a further wet seal area bordering said active area, said further wet seal area being defined by the region between a flat section of a second one of said two flanges and a portion of said first surface of said plate structure opposite that flat section, said further compliant member comprising a further body member having further sections extending outwardly of the plane of the further body member, said further sections imparting compliance to said further compliant member.

23. A fuel cell according to claim 18, wherein said body member is configured to fit within said wet seal area.

24. A fuel cell according to claim 18, wherein said body member is flat and one side of each of said sections of said body member is joined to said body member.

25. A fuel cell according to claim 24, wherein the one side of each of said sections is on the same side of that section as the side that each other one side is on its respective section.

26. A fuel cell according to claim 24, wherein said body member and said sections are made from a superalloy material or spring.

27. A fuel cell according to claim 26, wherein in the uncompressed state of said compliant member: the side of each of said sections opposite said one side joined to said body member is disposed at a distance of 0.01-0.06 inches from said body member, and said sections extend outwardly of the plane of said flat body member at an angle of 2-50 degrees.

28. A fuel cell according to claim 27, wherein said angle is reduced as compressive load is applied to said fuel cell.

29. A fuel cell according to claim 28, wherein said sections are disposed in the plane of the flat body member when said compliant member is fully compressed.

30. A fuel cell according to claim 26 wherein said superalloy material is one of Inconel 718, Waspaloy and Rene-41.

31. A fuel cell according to claim 26 wherein said body member and each of said sections is rectangular.

32. A fuel cell according to claim 18, wherein, said sections are arranged in rows which extend along the length of said body member and which are spaced along the width of said body.

33. A fuel cell according to claim 32, wherein one side of each of said sections of said body member is attached to said body member.

34. A fuel cell according to claim 33, wherein said one side of each of said sections extends along one of the length of said body member and the width of said body member.

35. A fuel cell according to claim 34, wherein the one side of each of said sections extends along the length of said body member.

36. A fuel cell according to claim 34, wherein the one side of each of said sections extends along the width of said body member.

37. A fuel cell according to claim 32, wherein said rows of sections are offset one from the other in the length direction of said body member.
